(19) United States
(12) Patent Application Publication
(10) Pub. No.: US 2012/0266070 A1
(43) Pub. Date: Oct. 18, 2012

(54) Selectable Point of View (SPOV) Graphical User Interface for Animation or Video

(76) Inventor: Maurice T. Lough, Murray, KY (US)

(21) Appl. No.: 13/443,866

(22) Filed: Apr. 10, 2012

Related U.S. Application Data
(60) Provisional application No. 61/476,259, filed on Apr. 16, 2011.

(51) Int. Cl. G06F 3/048

(52) U.S. Cl. 715/722

(57) ABSTRACT

A method for allowing a viewer or user of an animation or video to select from among a number of available points of view consists of the viewer or user interacting with a graphical user interface containing control elements designed for this purpose.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to the field of graphical user interfaces for animation or video, and, more particularly, to a method for providing a viewer or user the ability to select from among a number of available points of view.

2. Related Art Background

In general, a graphical user interface enables a viewer or user to interact with a graphical display such as one that is typically shown on a computer display in order to set parameters, control events, etc. The viewer or user can interact with various objects [e.g., menus, toolbars, dialog boxes, buttons] or areas on the display in a number of ways, including but not limited to using a mouse, a fingertip, a remote control, or other hand-held or pointing device to select, click, double click, drag, rotate, resize, etc. While this general graphical user interface concept performs well with currently available animation and video products for typical viewing actions such as starting and pausing, there is no known provision for a viewer or user to control an animation or video with a selectable point of view feature. As will be described, the present invention provides a graphical user interface that addresses this need. This selectable point of view graphical user interface may also be applied to a variety of other viewing applications in addition to computers. These include but are not limited to cell phones, graphics tablets, other mobile devices, television, cinema, and similar communication systems.

### BRIEF SUMMARY OF THE INVENTION

In accordance with the present invention, a method is provided for implementing a graphical user interface that allows a viewer or user to select different points of view while observing an animation or video. An animation or video is typically depicted with at least two on-screen components: a relatively large display area and one or more smaller control areas. The control area(s) may or may not be visible continuously. The method comprises the steps of the viewer or user interacting with the control area(s) or specially activated regions of the display area to select a different point of view for the animation or video. This selection can be made prior to the start of the animation or video. However, selections of points of view can also be made during the animation or video itself, as opportunities to do so are presented. This and other features of the invention are described in greater detail below.

The graphical user interface of the present invention provides opportunities for a viewer or user to interact with objects within the control area(s) or activated regions within the display area to change the point of view of an animation or video. While generally there would exist a one-to-one relationship between each object or activated region and a particular available point of view, it is also possible to present to the viewer or user two or more options for the same point of view. For example, an option of the point of view of another person in the animation or video might be indicated by an object in the control area and also by a cue on or near the other person on the screen.

### BRIEF DESCRIPTIONS OF THE SEVERAL VIEWS OF THE DRAWINGS

The objects, features, and advantages of the present invention will be apparent to one skilled in the art, in view of the DETAILED DESCRIPTION OF THE INVENTION following, in which:

FIG. 1 illustrates a general graphic display, with the frame [11] and the viewing area [12].

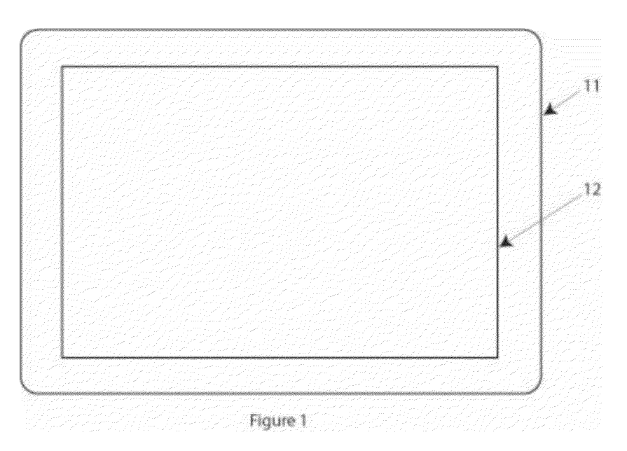

FIG. 2 illustrates a more detailed graphic display, with the animation or video [21], typical playback controls [22, 23, 24], example of a possible selectable point of view control panel with graphic objects representing available points of view [25], example of a possible cue for a selectable point of view within the viewing area [26], and example of possible selectable point of view control panel with tabs, dropdown menus, or other similar objects [27].

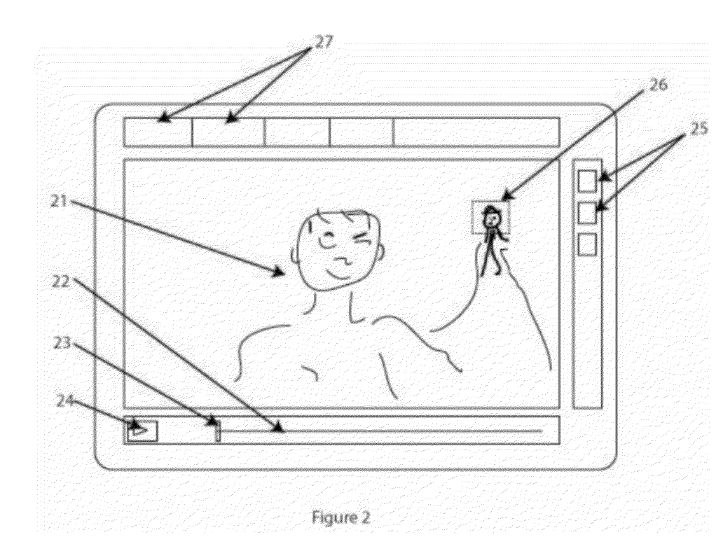

FIG. 3 illustrates the general design of an animation or video with the ability of a viewer or user to switch to other points of view [A, B, C] at any time, with the starting event [31], examples of events in which the point of view is switched [32, 33, 34, 35], and the ending event [36].

FIG. 4 illustrates the general design of an animation or video with the ability of a viewer or user to switch to other points of view [A, B, C] only when these points of view are available, with the starting event [41], examples of events in which the point of view is switched [42, 43, 44, 45, 46], and the ending event [47].

FIG. 5 illustrates the relationship between the graphic display area as seen by the viewer or user and the design of a simple animation consisting of two points of view that are available at any time, with the starting event [51], examples of events in which the point of view is switched [52, 53], the ending event [54], example of the depiction of the present point of view [55], example of the depiction of an available point of view [56], and a tag identifying each specific point of view [57].

### DETAILED DESCRIPTION OF THE INVENTION

The graphic display area of an animation or video generally includes a frame [11] and a viewing area [12]. The graphical user interface (GUI) for animation or video [21] includes resources for a viewer to control certain aspects of the animation or video. For example, a typical GUI would include a button to start and stop the animation or video [22]. Many other control resources are possible [23, 24]. This utility patent application focuses on a new viewing process, and especially on the GUI to control this innovative process. In particular, this application focuses on the GUI to control a process which allows a viewer to select from among two or more different points of view during the animation or video [25, 26, 27]. Such an interface could be called a selectable point of view graphical user interface, or SPOV GUI.

The concept of different points of view is not new. For example, in a television studio control room, the producer observes the real time video feed from a number of cameras, each focused some aspect of the same event. At a sporting event, there might be two television cameras down near the competing teams, one camera on the side for interviews, another at the top of the seating area for establishing shots, and yet another in the broadcast booth to show the commentators.

It is the job of the producer to select which camera feed to send out for the broadcast to the viewing public within any given period of time. In this manner, the producer selects the various points of view throughout the broadcast for the public.

Different points of view are also chosen for the public by the producer of a motion picture. Although each scene might be recorded by multiple cameras, the producer selects which points of view are seen and in which order throughout the production. As with the sporting event television broadcast, the public does not have the option to select a point of view at any time.

With a SPOV GUI, the viewer would be able to select the desired point of view at any point this option is available in an animation or video. This patent application focuses on the SPOV concept and how it might be implemented through a GUI.

An animation or video is typically depicted in a full screen mode [21]. Currently, some control options are available and usually take the form of a smaller control area presented in conjunction with a larger display area. Current control options include stop and pause [22], volume control, and the ability to move the animation or video to a particular spot along the playing timeline [23, 24]. However, current control options do not include the selection of different points of view.

The method comprises the steps of the user using the control area to (a) select an available point of view at the start of an animation or video and/or (b) select from among additional points of view as available during the running of the animation or video.

A changing point of view has been part of practically every motion picture produced since cinematography began. Once directors and producers discovered that audiences could easily transfer their attention from one scene to a scene with a different point of view, filmmakers developed several typical sequences with changing points of view to draw audience members into the story.

One typical sequence with a changing point of view begins with what is called an establishing shot, consisting of several seconds of footage of an object at a distance, such as a house. In the next scene, several seconds of footage of the exterior of the house from 10 or 20 feet away might be shown, followed by a shot of the front door. Finally, an interior shot shows the characters of the film as they begin to interact with each other. Such a sequence plays a powerful role in creating the setting for the audience members.

The changing points of view engage the audience, draw them into the story, and keep the film interesting. However, these changing points of view in a film are not controlled by the audience members. Instead, they were controlled by the production staff of the film company.

The same general approach is also used in an animation and video viewed with a SPOV GUI. In this case, however, for the first time the viewer or user has control of the point of view. SPOV animations and videos can be manipulated in ways not possible with film productions because the graphical information is stored in a digital format. In these cases, a new graphical user interface for selecting points of view in such animations and video would represent an advance of great significance and value. Moreover, such a concept could be applied to many different types of animations and video, including those designed for educational use.

No particular programming language has been indicated for carrying out the various procedures described herein. This is due in part to the fact that not all languages that might be mentioned are universally available. Each user of a particular computer will be aware of a language which is most suitable for his/her immediate purposes. In practice, it is probably most useful to implement the present invention in a high level language which would then be compiled into machine executable object code. Because the computers and the display systems which may be used in practicing the instant invention consist of many diverse elements, no detailed program listing has been provided. It is considered that the operations and other procedures described herein and illustrated in the accompanying drawings are sufficiently disclosed to permit one of ordinary skill to practice the instant invention.

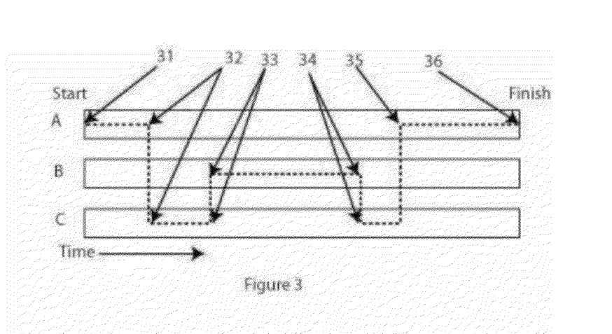

FIG. 3 illustrates an example of the production design of a SPOV animation or video with three continuously available points of view [A, B, C]. The timelines for all three points of view are available at any time during the animation or video. After the start [31], the viewer or user might select point of view C at a particular moment [32], then switch to point of view B [33], return to point of view C [34], and near the end switch to the original point of view [35], in time for the finish [36]. The switching of points of view can be achieved by the viewer or user interacting with appropriate control elements [25, 26, 27] at the desired times.

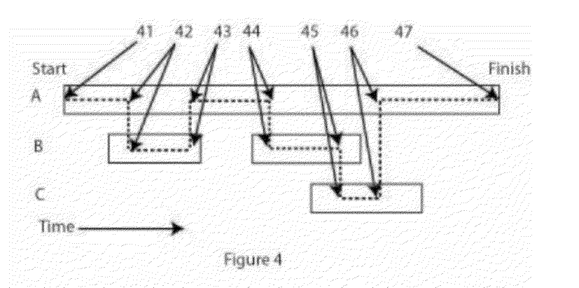

FIG. 4 illustrates an example of the production design of a SPOV animation or video with three points of view [A, B, C], not all of which are available continuously during the animation or video. This particular example might apply to a production situation in which budgetary, logistical, or other constraints limit the availability of points of view. After the start [41], the viewer or user might select point of view B when it becomes available [42], and then be returned to the original point of view A at the end of B′s availability [43]. At a later time in the animation or video, point of view B might become available once more, and the viewer or user might select it [44]. However, when point of view C becomes available also, the viewer or user might select it at that time [45]. The viewer or user might decide to return to the original point of view [46] in time for the finish of the animation or video [47].

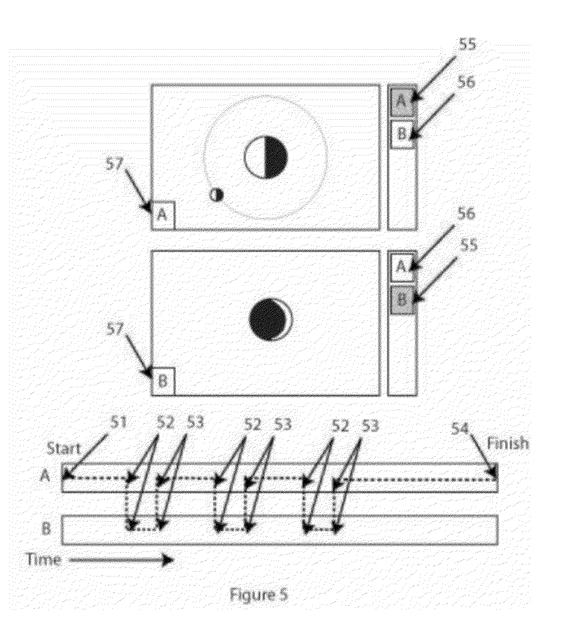

FIG. 5 illustrates an example of the application of the present invention to a simple two-track animation designed to help students become more familiar with the phases of the moon and their relationship to the angular orientation of the sun, earth, and moon. In this example, the student is able to select from among two points of view as the moon revolves around the earth.

Point of view A shows the earth and moon as seen from a position above the North Pole. The sun is off-screen to the left, and the sides of the earth and moon which face the sun are depicted in white. The sides away from the sun are depicted in black, indicating that these regions receive no direct sunlight. Point of view B shows the moon as seen from the surface of the earth. In the specific frames shown, the moon is in the “eight o'clock” position as seen from point of view A, and only a small portion of the illuminated side of the moon is visible from earth, as seen from point of view B.

After the animation begins [51], the viewer or user is able to switch between the two available points of view at will [52, 53], until the animation finishes [54]. During the running of the animation, this example shows one way to implement the SPOV GUI by highlighting the point of view available for selection [56] while de-emphasizing or graying out the current point of view [55]. For the convenience of the reader, the two points of view are tagged [57] in this figure.

The present invention has been described in the context of a functioning animation or video that was produced with the feature of selectable points of view embedded within it. Those with ordinary skill in the art of animation and video design and production will appreciate that it is possible to implement the processes of the present invention in a number of different forms and formats.

The narrative of the present invention has been given for the purposes of illustration and description, and is not intended to be exhaustive or limited to the invention in the form disclosed. Many modifications and variations will be apparent to those of ordinary skill in the art of animation and video design and production. The embodiment was chosen and described in order to explain the principles and practical application of the invention, and to enable others of ordinary skill in the art of animation and video design and production to understand the invention for other embodiments with various modifications as are suited to their particular contemplated uses.

Licenses are available from the inventor upon request.

What is claimed is:

1-7. (canceled)

8. A method for providing a user with a capability of selecting from among different available points of view while observing one of an animation and a video, the method comprising the steps of:
providing the user with a graphical user interface; and
providing the user with a capability of operating the graphical user interface to select a desired point of view.

9. The method of claim 8, further comprising the step of providing the graphical user interface with a control area and a display area, wherein the user interacts with the graphical user interface to select the desired point of view.

10. The method of claim 9, wherein the control area is visible to the user when at least one additional point of view is available for selection by the user.

11. The method of claim 9, further comprising the step of providing the control area with at least one selection component including at least one of icons and radio buttons corresponding to at least one different available point of view.

12. The method of claim 9, further comprising the step of providing the display area with a plurality of displays of a selected point of view and at least one different selectable point of view.

13. The method of claim 12, further comprising the step of providing the control area with indicators of the selected point of view and said at least one different selectable point of view.

14. The method of claim 12, further comprising the step of providing the control area with selection buttons for selecting said at least one different selectable point of view.

15. The method of claim 8, wherein certain areas within said one of the animation and the video are designated for selection as the available points of view.

16. The method of claim 8, further comprising the step of interacting with the graphical user interface in any of a number of ways, including use of at least one of a mouse, a fingertip, a remote control, a hand-held device, and a pointing device to select from among the different available points of view.

17. A graphical user interface for providing a user with a capability of selecting from among different available points of view while observing one of an animation and a video, comprising:
a display area for displaying a selected point of view and at least one different available point of view; and
a control area including indicators of the selected point of view and said at least one different available point of view, and at least one selection button for selecting said at least one different available point of view.

18. the graphical user interface of claim 17, wherein the control area is visible to the user when at least one additional point of view is available for selection by the user.

19. The graphical user interface of claim 17, wherein said control area comprises at least one selection component including at least one of icons and radio buttons corresponding to said at least one different available point of view.

20. The graphical user interface of claim 17, wherein said display area includes a plurality of displays of said selected point of view and said at least one different available point of view.

21. The graphical user interface of claim 20, wherein said control area includes indicators of said selected point of view and said at least one different available point of view.

22. The graphical user interface of claim 20, wherein said control area includes selection buttons for selecting said at least one different available point of view.

23. The graphical user interface of claim 17, wherein the user interacts with the graphical user interface in any of a number of ways, including use of at least one of a mouse, a fingertip, a remote control, a hand-held device, and a pointing device to select from among the different available points of view.
